(19) United States
(12) Patent Application Publication
(10) Pub. No.: US 2014/0350869 A1
(43) Pub. Date: Nov. 27, 2014

(54) DEVICE, METHOD, AND PROGRAM FOR CRASH SIMULATION

(71) Applicant: INTERNATIONAL BUSINESS MACHINES CORPORATION, Armonk, NY (US)

(72) Inventors: Tsuyoshi Ide, Kanagawa-ken (JP); Raymond Harry Rudy, Kanagawa-ken (JP)

(73) Assignee: INTERNATIONAL BUSINESS MACHINES CORPORATION, Armonk, NY (US)

(21) Appl. No.: 14/277,396

(22) Filed: May 14, 2014

(30) Foreign Application Priority Data
May 22, 2013 (JP) 2013-107771

(51) Int. Cl. G01M 17/007

(52) U.S. Cl. CPC G01M 17/007
USPC 702/35

(57) ABSTRACT

Device, method, and program for analyzing deformation in an object during crash simulation. A device for analyzing deformation in an object is provided. The device includes: a memory; a processor device communicatively coupled to the memory; and a module for analyzing deformation in an object coupled to the memory and the processor device to operate the following units: an acquisition unit for acquiring coordinate data along a time series at a plurality of points in the object; a calculation unit for calculating an amount of deformation feature indicating an amount of deformation in the object over time from the coordinate data at the plurality of points at each time in the time series; and a storage unit for setting the time series data for the amount of deformation feature as data for specifying a deformed state of the object, associating said data with the object, and storing the associated data.

### CROSS-REFERENCE TO RELATED APPLICATION

This application claims priority under 35 U.S.C. §119 from Japanese Patent Application No. 2013-107771 filed May 22, 2013, the entire contents of which are incorporated herein by reference.

### BACKGROUND OF THE INVENTION

1. Field of the Invention

The present invention relates to crash simulations. More particularly, the present invention is related to a method, device, and program for analyzing deformation in an object.

2. Description of Related Art

One method for evaluating the results of a crash simulation performed on a vehicle, such as an automobile, is to set a plurality of nodes (or measurement points) on a vehicle, establish a reference point among these nodes, and focus on the displacement (amount of recession) in the reference point relative to a known fixed axis such as the direction of travel (see, for example, Japanese Patent Application No. 2005-115770 and Japanese Patent Application No. 2010-127933).

### SUMMARY OF THE INVENTION

According to one aspect of the present invention, a device for analyzing deformation in an object is provided. The device includes: a memory; a processor device communicatively coupled to the memory; and a module for analyzing deformation in an object coupled to the memory and the processor device to operate the following units: an acquisition unit for acquiring coordinate data along a time series at a plurality of points in the object; a calculation unit for calculating an amount of deformation feature indicating an amount of deformation in the object over time from the coordinate data at the plurality of points at each time in the time series; and a storage unit for setting the time series data for the amount of deformation feature as data for specifying a deformed state of the object, associating said data with the object, and storing the associated data.

According to a second aspect of the present invention, a method for analyzing deformation in an object is provided. The method includes: acquiring coordinate data along a time series at a plurality of points in the object; calculating an amount of deformation feature indicating an amount of deformation in the object over time from the coordinate data at the plurality of points at each time in the time series; and setting the time series data for the amount of deformation feature as data for specifying a deformed state of the object, associating said data with the object, and storing the associated data.

According to a third aspect of the present invention, a non-transitory computer program product for analyzing deformation in an object is provided. The non-transitory computer program product includes: a computer readable storage medium having program instructions embodied therewith, the program instructions readable/executable by a device to cause the device to perform a method including: acquiring coordinate data along a time series at a plurality of points in the object; calculating an amount of deformation feature indicating an amount of deformation in the object over time from the coordinate data at the plurality of points at each time in the time series; and setting the time series data for the amount of deformation feature as data for specifying a deformed state of the object, associating said data with the object, and storing the associated data.

This summary of the present invention is not intended to enumerate all of the required characteristics of the present invention. The present invention can be realized by any combination or sub-combination of these characteristics.

### BRIEF DESCRIPTION OF THE DRAWINGS

FIG. 1 shows the configuration of the analysis device 100, according to an embodiment of the present invention.

FIG. 2 shows the processing flow for the analysis method performed by the analysis device 100, according to an embodiment of the present invention.

FIG. 3 shows an object at the reference time (before a crash).

FIG. 4 shows the object at time t (after the crash).

FIG. 5 shows a summary of the calculation of the amount of deformation feature as performed by the analysis device 100, according to an embodiment of the present invention.

FIG. 6 shows a graph generated from the time series for the amount of rotation feature related to a plurality of objects.

FIG. 7 shows a graph generated from the time series for the amount of expansion and contraction feature related to a plurality of objects.

FIG. 8 shows a graph in which the amount of deformation feature related to a plurality of objects has been visualized using multidimensional scaling.

FIG. 9 shows the processing flow for the analysis method performed, according to an embodiment of the present invention.

FIG. 10 shows an example of a hardware configuration for computer 1900, according to an embodiment of the present invention.

### DETAILED DESCRIPTION OF THE PREFERRED EMBODIMENTS

When the amount of recession at a reference point is focused on, the total deformation of the object during a crash is difficult to grasp intuitively, and it is not easy to discover the relevance of results among a plurality of objects. As a result, it is difficult to make design improvements to an object by using the results from a simulation performed on a plurality of objects.

According to one aspect of the present invention, a device for analyzing deformation in an object is provided which includes: an acquisition unit for acquiring time series data such as coordinates, speed and acceleration at multiple points on the surface or in the interior of an object; a calculation unit for calculating the amount of feature deformation indicating the amount of deformation in the object over time from the values at each time in the time series; and a storage unit for setting the time series data for the amount of feature deformation as data for specifying the deformed state of the object, and for associating said data with the object and storing the associated data. The present invention also provides an analysis method and a program in which this analysis device is used.

The following is an explanation of an embodiment of the present invention. However, the present embodiment does not limit the present invention in the scope of the claims. Also, all combinations of characteristics explained in the embodiment are not necessarily required in the technical solution of the present invention.

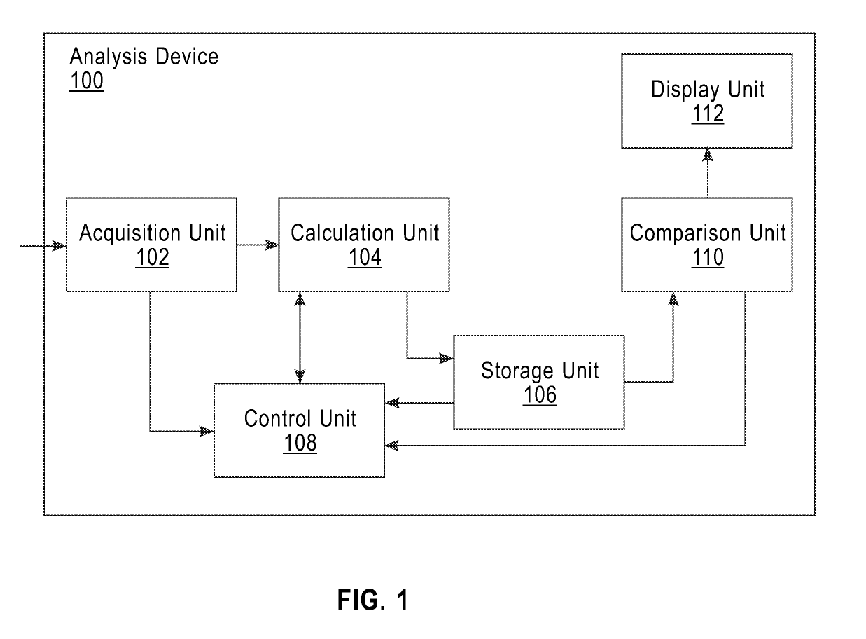

FIG. 1 shows the configuration of analysis device 100, according to an embodiment of the present invention. Analysis device 100 provides useful data for designing objects by analyzing the deformation of an object (for example, a vehicle such as an automobile) in a crash simulation. In the present embodiment, deformation of the object includes rotation of the object, expansion and contraction of the object, and any change in the shape of the object. Analysis device 100 includes an acquisition unit 102, a calculation unit 104, a storage unit 106, a control unit 108, a comparison unit 110, and a display unit 112.

Acquisition unit 102 acquires coordinate data in a time series during a crash at multiple nodes on the surface of and/or the interior of one or more objects from, for example, a database in which the results of crash simulations performed on a vehicle are stored. Acquisition unit 102 supplies the acquired coordinate data for the object to a calculation unit 104.

Calculation unit 104 calculates the amount of deformation feature indicating the amount of deformation of the object at a given time from the coordinate data for the object at multiple points in each time in the time series. Calculation unit 104 stores the time series data for the calculated amount of deformation feature in storage unit 106.

Storage unit 106 sets the time series data for the amount of deformation feature as data for specifying the deformed state of the object over time, and associates said data with the object and stores the associated data. Storage unit 106 also stores object information related to object deformation which has been associated with a plurality of objects and inputted by the user (such as object design information), and evaluation values assigned to a plurality of objects (such as for evaluation of the shape of the objects).

Control unit 108 controls the calculation of the amount of deformation feature by calculation unit 104. For example, control unit 108 controls the objects and the times in the time series to be used by calculation unit 104 to calculate the amount of deformation feature. When the amount of deformation feature in the objects calculated by calculation unit 104 at a set of the times in the time series satisfies predetermined conditions, control unit 108 controls calculation unit 104 so as to reduce the priority for calculating the amount of deformation feature in the objects, or to stop the calculation of the amount of deformation feature in the objects.

Comparison unit 110 reads the time series data on the amount of deformation feature in two or more objects from storage unit 106 and compares the data. It then generates a graph in which the relationship of the time series data for the amount of deformation feature in the objects is visualized using a dimension reduction method such as multidimensional scaling. In this way, comparison unit 110 makes the results of a crash simulation performed on a plurality of objects easier to understand intuitively. Comparison unit 110 supplies the generated graph to display unit 112.

Also, comparison unit 110 can specify another object with time series data on the amount of deformation feature that is similar to the one object. Comparison unit 110 searches the information stored in storage unit 106 for another object whose aspects of deformation resembled those of the one object in the crash simulation. Comparison unit 110 can retrieve object information associated with another specified object from storage unit 106 and send this information to display unit 112.

Display unit 112 displays the results of a comparison of more than one object by comparison unit 110. For example, the display unit 112 displays a graph visualizing the distance between time series data on the amount of deformation feature in a plurality of objects. Also, display unit 112 can display other specified objects and object information associated with these other specified objects.

In this way, analysis device 100 in the present embodiment calculates time series data on the amount of deformation feature of each object from measurement data such as coordinates measured as the time series data, and displays a graph visualizing the distance between time series data for the amount of deformation feature. Analysis device 100 thus displays the results of a crash simulation in a manner that is easy to understand intuitively. Analysis device 100 can also detect the relevance of the deformation in a plurality of objects.

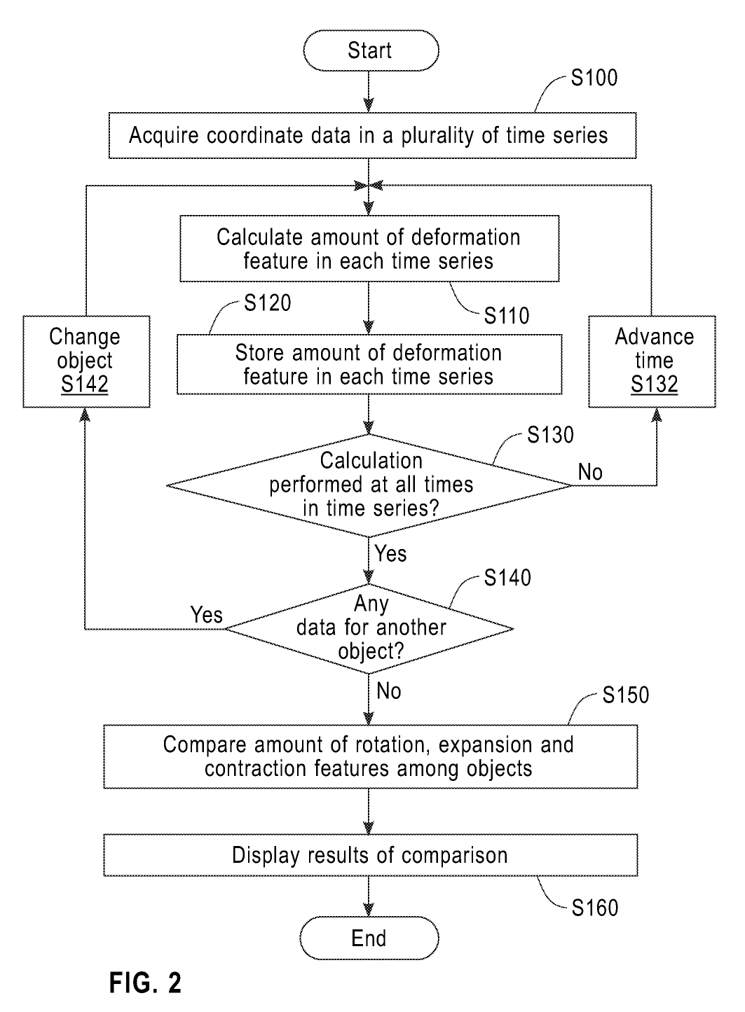

FIG. 2 shows the processing flow for the analysis method performed by analysis device 100, according to embodiment of the present invention. In the present embodiment, analysis device 100 executes the process of Step 100 through Step 160.

First, in Step 100, acquisition unit 102 acquires coordinate data in a time series for a plurality of objects. For example, acquisition unit 102 acquires three-dimensional coordinate data, at a plurality of points constituting an object in a time series, from a database storing the results of a crash simulation in which a structure having a plurality of points has been simulated using, for example, the finite element method. In one example, acquisition unit 102 acquires coordinate data for an object at 1,000 points in time within a 10 millisecond time span. The intervals between time points in the time series can be equal or unequal.

As coordinate data along the time series for a plurality of objects, acquisition unit 102 can acquire the results of a crash simulation in which the same object (such as the same vehicle model) is crashed multiple times under different crash conditions such as impact point, impact speed, and/or impact angle. Also, acquisition unit 102 can acquire results from a crash simulation in which different objects (for example, different vehicle models with varying numbers of nodes) are crashed under the same crash conditions. Acquisition unit 102 supplies the acquired object coordinate data to a calculation unit 104.

In Step S110, calculation unit 104 calculates the amount of deformation feature to a single object at a single time. For example, control unit 108 supplies calculation unit 104 with information on an object whose amount of deformation feature is to be calculated by calculation unit 104 and information on the time t in the time series. Calculation unit 104 calculates the amount of rotation feature indicating the amount the object has been rotated around its center of gravity, and/or the amount of expansion and contraction feature indicating the amount the object has expanded and contracted at time t, as the amount of deformation feature, on the basis of coordinate data on the object received from acquisition unit 102. The following is a detailed explanation of an example of a method used by calculation unit 104 to calculate the amount of rotation feature and the amount of expansion and contraction feature.

First, calculation unit 104 calculates the geometric or mechanical center of gravity of the object at a reference time from the coordinate data for each point of the object at the reference time (for example, time t=0 just prior to the crash). For example, calculation unit 104 can use the average coordinates of a multitude of points or the weighted average coordinates of a multitude of points as the center of gravity of the object, or can use a representative point or nearby point of an object as defined by the user. Calculation unit 104 creates a matrix X=[x1, x2, x3, . . . , xn]^{T} from the coordinate data x1, x2, x3, . . . , xn for each point with respect to the calculated center of gravity at a reference time (here, x1 through xn are vectors indicating the three-dimensional coordinates of each point in the object at a reference time). Here, n denotes the number of nodes (points) included in an object.

Calculation unit 104 also calculates the geometric or mechanical center of gravity of an object at time t from the coordinate data for each point in the object at time t in the time series. Calculation unit 104 creates a matrix Y=[y1(t), y2(t), y3(t), . . . , yn(t)]^{T} from the coordinate data y1(t), y2(t), y3(t), . . . , yn(t) for each point with respect to the calculated center of gravity at time t (here, y1(t) through yn(t) are vectors indicating the three-dimensional coordinates of each point in the object at time t).

Here, calculation unit 104 rotates the coordinates for the object in matrix X at the reference time by the amount of rotation feature R(t) and scales the matrix by the total amount of expansion and contraction feature ρ(t) to obtain matrix X′=[x′1, x′2, x′3, . . . , x′r, . . . x′n]^{T}, as shown in Equation 1. At this time, the amount of rotation feature R(t) and the amount of the total expansion and contraction feature ρ(t) are calculated to minimize H(t) shown in Equation 2. H(t) expresses the difference between the coordinate data for one object at time t and the coordinate data for the object after rotation, expansion and contraction of the object at reference time, and expresses the change in the shape of the object from the reference time to time t, excluding the influence of rotation, expansion and contraction.

$$\begin{matrix}Equation 1 & \\ {x}_{r}^{′} = ρ ( t ) {R ( t )}^{T} {x}_{r} & ( 1 ) \\ Equation 2 & \\ H ( t ) = {\sum }_{r = 1}^{N} {( {y ( t )}_{r} - {x}_{r}^{′} )}^{T} ( {y ( t )}_{r} - {x}_{r}^{′} ) & ( 2 )\end{matrix}$$

For example, calculation unit 104 can calculate the amount of rotation feature R(t) and the total amount of expansion and contraction ρ(t) on the basis of a shape analysis method such as Procrustes analysis. For example, as shown in Equation 3, calculation unit 104 performs singular value analysis on the product of the transposed matrix Y^{T}(t) of the matrix Y(t) obtained from the coordinate data of an object at time t in the time series and matrix X obtained from the coordinate data of the object at the reference time, in order to obtain matrix U, the amount of expansion and contraction feature Γ(t) in three dimensions, and matrix V. The amount of expansion and contraction feature Γ(t) in three dimensions is a 3×3 diagonal matrix when x1 through xn and y1(t) through yn(t) are three-dimensional vectors, and the diagonal component represents the expansion and contraction of the object in each of the three-dimensional directions at time t.

$$\begin{matrix}Equation 3 & \\ {Y}^{T} ( t ) X {}^{Singular Value Decomposition} U Γ ( t ) {V}^{T} & ( 3 )\end{matrix}$$

As shown in Equation 4, calculation unit 104 calculates the amount of rotation feature R(t), which is a vector amount representing the amount of rotation of an object at time t, from the product of matrix V and the transposed matrix U^{T} of matrix U. The amount of rotation feature R(t) is a 3×3 matrix when x1 through xn and y1(t) through yn(t) are three-dimensional vectors, and represents the rotation of the object in three-dimensional space at time t.

Equation 4

R(t)=VU^{T} (4)

As shown in Equation 5, calculation unit 104 calculates the total amount of expansion and contraction feature ρ(t), which is a scalar quantity indicating the total amount of expansion and contraction of the object at time t, on the basis of matrix X and matrix Y(t). The total amount of expansion and contraction feature ρ(t) is a scalar quantity, and represents the overall scaling factor of the object at time t.

$$\begin{matrix}Equation 5 & \\ ρ ( t ) = \frac{{tr ( {X}^{T} Y ( t ) {Y ( t )}^{T} X )}^{\frac{1}{2}}}{tr ( {X}^{T} X )} & ( 5 )\end{matrix}$$

Also, as shown in Equation 6, calculation unit 104 can calculate the amount of shape deformation feature H(t), which is a scalar quantity indicating the change in the shape of the object from the reference time excluding the influence of rotation and expansion and contraction at time t and which is normalized so that the maximum value is 1, on the basis of matrix X and matrix Y(t).

$$\begin{matrix}Equation 6 & \\ Normalized H ( t ) = 1 - \frac{\{ {tr ( {X}^{T} Y ( t ) {Y ( t )}^{T} X )}^{\frac{1}{2}} \}}{\{ tr ( {X}^{T} X ) tr ( {Y ( t )}^{T} Y ( t ) ) \}} & ( 6 )\end{matrix}$$

In this way, calculation unit 104 calculates the amount of rotation feature R(t), the diagonal component of the amount of expansion and contraction feature in three dimensions Γ(t), the total amount of expansion and contraction feature ρ(t), and the amount of shape deformation feature H(t) of an object at time t in a time series. Calculation unit 104 can calculate these amounts of deformation feature using a solution to the optimization problem other than Procrustes analysis (such as by the gradient method).

In Step S120, calculation unit 104 sets data such as the amount of rotation feature R(t), the diagonal component of the amount of expansion and contraction feature in three dimensions Γ(t), the total amount of expansion and contraction feature ρ(t), and the amount of shape deformation feature H(t) at time t as data for identifying the deformed state of the object, associates said data with the object, and stores the associated data in the storage unit 106.

Calculation unit 104 can calculate the amount of rotation in the object, which is a scalar quantity, from the amount of rotation feature R(t), and can add this to the storage unit 106 in addition to or instead of the amount of rotation feature R(t).

In Step S130, control unit 108 determines whether the amount of rotation feature R(t), the amount of expansion and contraction feature in three dimensions Γ(t), the total amount of expansion and contraction feature ρ(t), and the amount of shape deformation feature H(t) of an object have been calculated at all times in the time series by the calculation unit 104. When calculation unit 104 has calculated the amount of deformation feature at all times, control unit 108 advances the process to Step S140. If not, it advances the process to Step S132.

In Step S132, control unit 108 advances time t to the next time (for example, by 1/100th of a millisecond), and returns to Step 110. In this way, control unit 108 causes calculation unit 104 in the next iteration of Step S110 to calculate the amount of deformation feature at the time following that of the previously calculated amount of deformation feature.

By repeating the processing from Step S110 to Step S132, calculation unit 104 calculates the amount of deformation feature in the object at all times in the time series, and stores the results in storage unit 106.

In Step S140, control unit 108 determines, from among coordinate data for multiple objects acquired by the acquisition unit 102 in Step S100, whether or not coordinate data is present for another object whose amount of deformation feature has not been calculated. When coordinate data for another object is present, control unit 108 advances the process to Step S142. When coordinate data for another object is not present, control unit 108 advances the process to Step S150.

In Step S142, control unit 108 changes the object to be processed in Step S110 through Step S132 to another object. The processing in Step S110 through Step S142 can then be repeated by calculation unit 104 to calculate the amount of deformation feature for multiple objects in the time series, and store the results in storage unit 106.

In Step S150, comparison unit 110 compares the time series data for the amount of deformation feature in two or more objects. For example, comparison unit 110 retrieves from storage unit 106 time series data for at least one of either the amount of rotation feature R(t), the diagonal component of the amount of expansion and contraction feature in three dimensions Γ(t), the total amount of expansion and contraction feature ρ(t), or the amount of shape deformation feature H(t) for two or more objects, generates a graph in which the time series data is plotted for each object, and calculates the distance between objects in the time series data for the purposes of comparison.

In one example, comparison unit 110 generates a graph in which the X-axis indicates the times in the time series, the Y-axis indicates the sum of the square of the difference between the amount of rotation feature R(t) and an element in unit matrix I (where unit matrix I corresponds to the amount of rotation feature R(t) when there has been no rotation), the amount of rotation calculated from the amount of rotation feature R(t) for each object has been plotted in the graph and line segments have been connected, and the distance between line segments for the objects has been calculated.

In another example, comparison unit 110 generates a graph in which the degree of expansion and contraction for an object on the first through third axes is indicated by the X-axis, the Y-axis and the Z-axis, the scaling factor of the object on the first through third axes calculated for each object from the diagonal components of the amount of expansion and contraction feature Γ(t) in three dimensions in a diagonal matrix for the object is plotted at each time in three dimensional space composed of the X-Z axes, the line segments are connected, and the distance between the line segments for the objects is calculated.

Comparison unit 110 can store values obtained for the distance from the line segments of each of the plurality of objects to the line segments of the other objects on the basis of the calculated results in storage unit 106 as evaluative values for each object. For example, comparison unit 110 can store, as an evaluative value for an object, the inverse of the average value for the distance from the line segment of the object to the line segment of one or more additional objects. In this way, comparison unit 110 can give a low evaluation value as a disparate object to an object whose aspects of deformation differ from the other objects.

Comparison unit 110 extracts objects manifesting disparate features on the basis of the distance to the line segments of a plurality of objects. For example, comparison unit 110 extracts objects for which the average distance to the line segments of the other objects exceeds a predetermined threshold value. In this way, comparison unit 110 can compare each object to the other objects and extract objects with distinctive deformation characteristics.

Comparison unit 110 generates a graph which visualizes the distances between the line segments of the plurality of objects using a method such as multidimensional scaling. In this way, comparison unit 110 can express the time series proximity of the amount of deformation feature in a plurality of objects as distances between dots or objects of graphs visualized in two- or three-dimensional space.

Also, comparison unit 110 receives one object indicated by the user, and specifies, as objects resembling the one object in terms of the amount of deformation feature, the objects whose distance to the line segment of the one object in terms of the amount of deformation feature such as the amount of rotation is less than a predetermined reference.

Comparison unit 110 retrieves object information associated with the other specified objects from storage unit 106. For example, when the object is a vehicle, comparison unit 110 retrieves, as object information, design information, design improvement information and/or operations associated with the other vehicles specified as resembling the one vehicle in terms of the amount of deformation feature. Comparison unit 110 supplies the graphs visualized using multidimensional scaling, other specified objects, and associated object information to display unit 112.

In Step S160, display unit 112 presents the other objects specified by comparison unit 110 and their associated object information to the user.

In this way, analysis device 100 in the present invention is able to perform a Procrustes analysis of the coordinate data for multiple objects in a time series, calculate the amount of rotation feature and amount of expansion and contraction feature of the objects in the time series, and use the resulting amounts of rotation feature and amounts of expansion and contraction feature to display the results of a crash simulation in a manner that is easy to understand intuitively. In particular, analysis device 100 is able to display the results of a crash simulation performed on multiple vehicle models, which differ in terms of the number of measurement points (nodes) and positions thereof, in a unified manner that is easy to understand.

In addition, analysis device 100 is able to analyze the relevance of deformation to a plurality of objects using the amount of rotation feature and the amount of expansion and contraction feature. In particular, because analysis device 100 is able to take into account differences in change between objects over time, results from a crash simulation can be analyzed more quickly without relying on the number and location of measurement points, as compared to methods focusing on the amount of recession.

Also, analysis device 100 can provide to a user, for example, design information on other objects which resemble an object specified by the user in terms of the amount of deformation feature, and which have a high probability of resembling the object in terms of structural features as well. For example, when an object is being designed by a user, analysis device 100 enables the user to consider design information on similar objects.

When the object is a vehicle, analysis device 100 can extract other vehicle models whose aspects of deformation resemble those of a particular model, and information useful in the design of other models can be used to design the particular model.

In Step S150 of the present embodiment, the analysis device 100 compares the deformation of a plurality of objects after the proximity of the amount of deformation feature in the plurality of objects in a time series has been visualized on a graph. However, analysis device 100 can compare the deformation in a plurality of objects without performing the graphing process, so as to identify, for example, objects that are similar and dissimilar to other objects in terms of aspect of deformation.

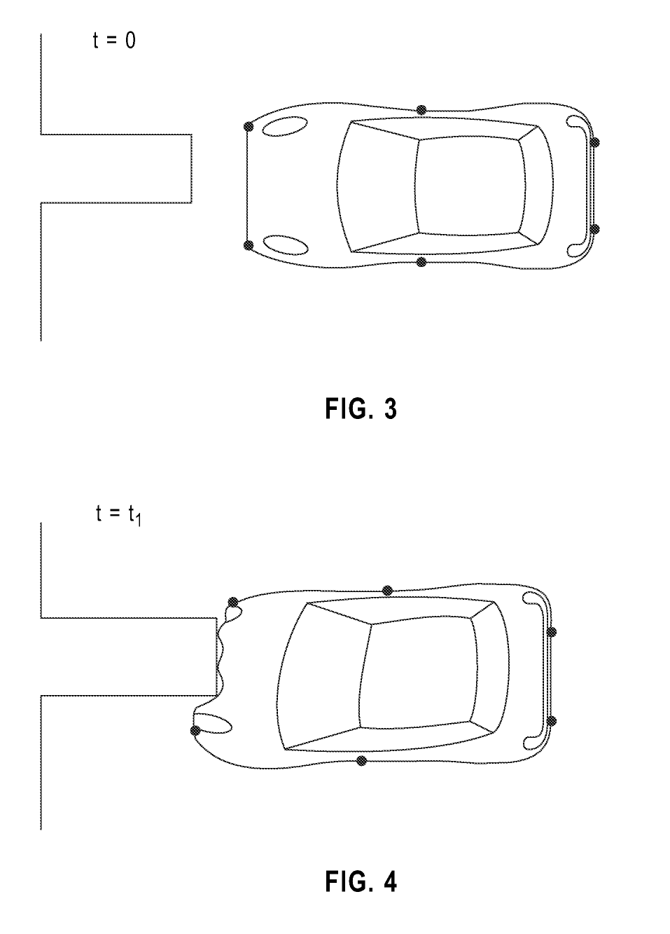

FIG. 3 through FIG. 5 summarize the condition of an object analyzed by analysis device 100 before and after a crash simulation. In the example shown in FIG. 3 through FIG. 5, analysis device 100 acquires coordinate data on a vehicle before and after an offset collision as coordinate data for an object in a time series. Analysis device 100 can acquire time series data for the coordinates of an object before and after a full-frontal collision as well.

FIG. 3 shows the vehicle at the reference time (t=0). As shown in the drawing, the vehicle has not hit a wall at the reference time and is thus not deformed. The six points on the vehicle shown in FIG. 3 indicate the locations on the object at which coordinate data was obtained by analysis device 100 at the reference time. The number of points on the object from which data is obtained by analysis device 100 can be increased in order to improve the accuracy of the analysis. Tens of thousands and even millions of points can be used.

FIG. 4 shows the vehicle at time t1. As shown in the drawing, a portion of the vehicle has collided with a wall and become deformed at time t1. For example, analysis device 100 acquires coordinate data at six points on the vehicle as coordinate data on the object at time t1.

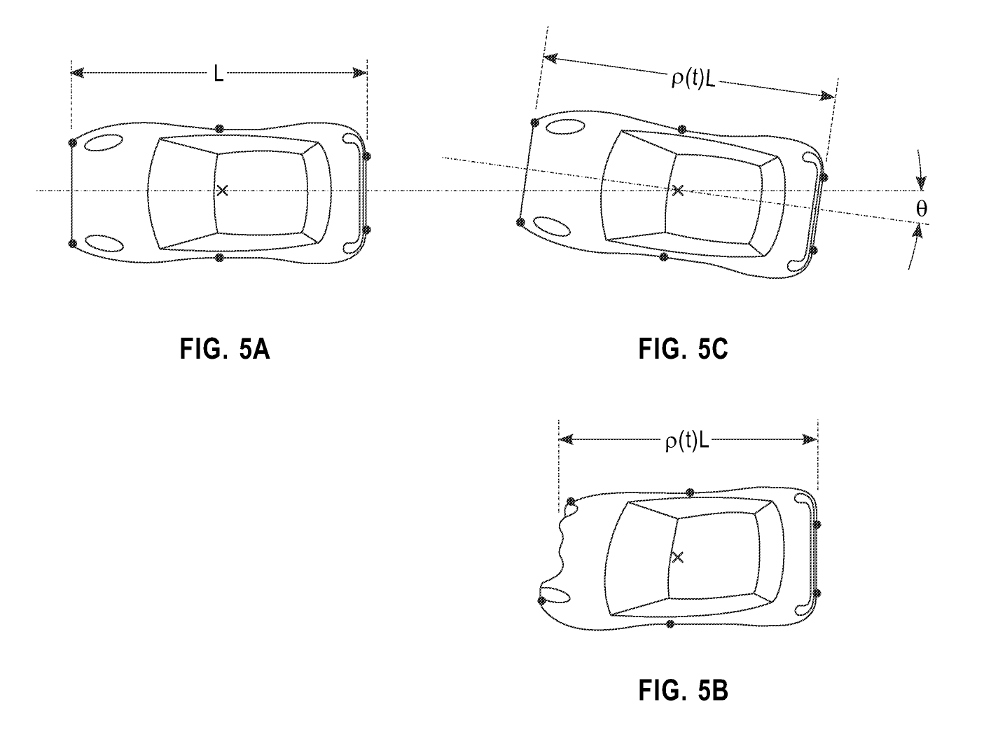

FIG. 5 shows a summary of the calculations performed by analysis device 100 in the present embodiment to calculate the amount of deformation feature. FIG. 5 (a) shows the vehicle at the reference time, and FIG. 5 (b) shows the vehicle at time t1. FIG. 5 (c) shows the state of the vehicle in FIG. 5 (a) after rotation and expansion and contraction which has minimized the amount of shape deformation feature H(t).

As shown in FIG. 5 (c), the vehicle in FIG. 5 (a) has been reduced by an overall amount of expansion and contraction feature ρ(t) of one or less, and has been rotated in the direction of rotation and by the amount of rotation obtained from the amount of rotation feature R(t). In this state, the amount of shape deformation feature H(t) between the vehicle in FIG. 5 (a) and the vehicle in FIG. 5 (b), that is, the difference in shape excluding the influence of rotation and expansion and contraction, has been minimized.

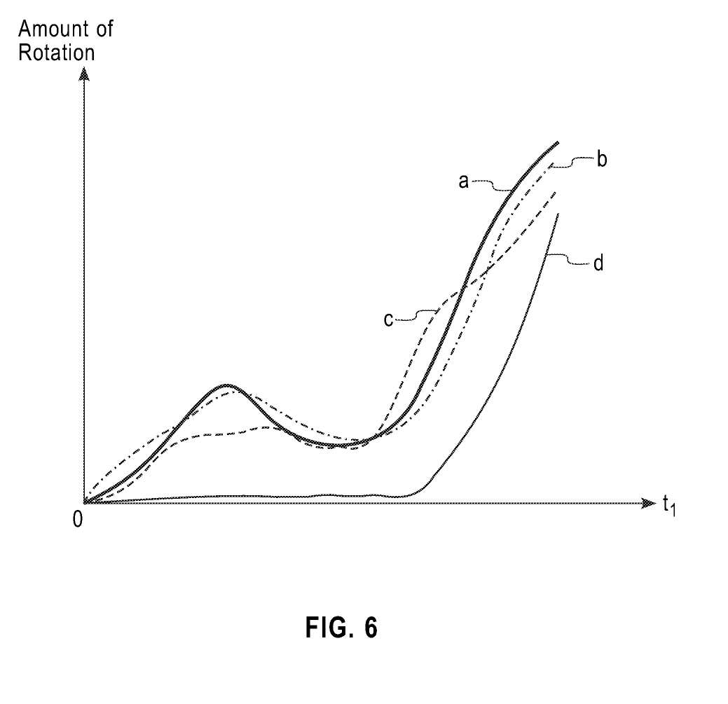

FIG. 6 shows a graph generated by comparison unit 110 from the time series for the amount of rotation feature related to a plurality of objects. The vertical axis in the graph shown in FIG. 6 indicates the amount of rotation by the object (the size of the rotated angle, for example, the distance from the unit matrix I), and the horizontal axis of the graph indicates the time in the time series. Line segments a through d in FIG. 6 indicate the amounts of rotation calculated from the amount of rotation feature R(t) for each of four objects which have been plotted in the graph.

As shown in the drawing, line segments a through c are plotted at a close relative distance, and line segment d is plotted in locations farther from line segments a through c. More specifically, line segments a through c indicate a situation in which the objects rotate, backtrack somewhat in the initial direction, and then rotate again. In contrast, line segment d indicates a situation in which the object hardly rotates at all initially but later rotates to a significant degree.

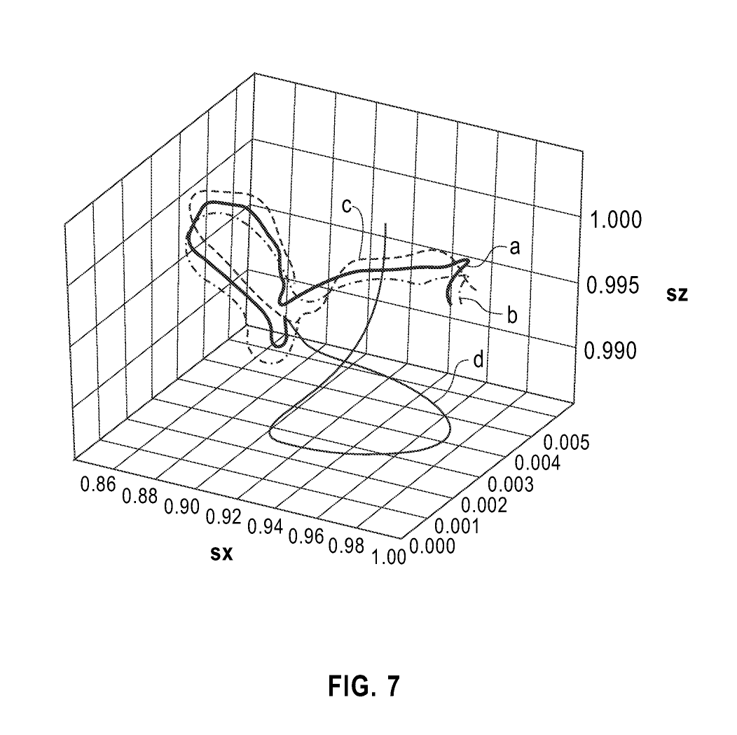

FIG. 7 shows a graph generated by comparison unit 110 from the time series for the amount of expansion and contraction feature Γ(t) in three dimensions related to a plurality of objects. In the graph shown in FIG. 7, the sx-axis, the sy-axis and the sz-axis indicate the scaling factor in the X, Y and Z axial directions. Line segments a through d in FIG. 7 are the scaling factors on the X, Y and Z axes as calculated from the diagonal portions for the amount of expansion and contraction features Γ(t) in three dimensions and plotted on the graph for each of the four objects.

As shown in the drawing, line segments a through c are plotted at a close relative distance, and line segment d is plotted in locations farther from line segments a through c. It is clear from FIG. 7 that the objects related to line segments a through c are scaled in three dimensions in the time series in a relatively close aspect, while the object related to line segment d is scaled in an aspect different from the objects related to line segments a through c.

FIG. 6 and FIG. 7 are examples in which the changes to objects in a time series have been plotted by comparison unit 110 on a graph on the basis of the amount of rotation feature R(t) or the amount of expansion and contraction feature in three dimensions Γ(t). However, the changes to objects in a time series can be plotted by the comparison unit 110 on a graph on the basis of a combination of one or more of the following: the amount of rotation feature R(t), the amount of expansion and contraction feature in three dimensions Γ(t) and the overall amount of expansion and contraction feature ρ(t). In addition, the changes to objects in a time series can be plotted by comparison unit 110 on a graph on the basis of the amount of shape deformation feature H(t).

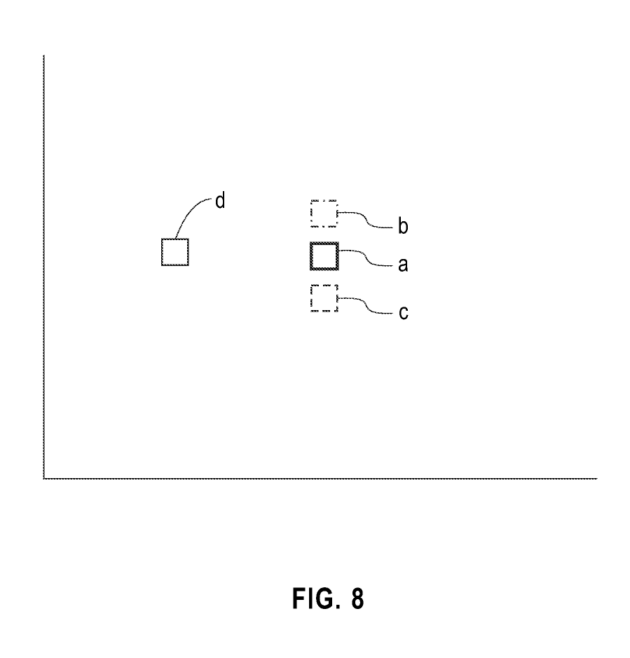

FIG. 8 shows a graph in which the distances between objects in terms of the amount of deformation feature has been visualized using multidimensional expansion and contraction in which the relationship between class objects is expressed by an arrangement of points in low-dimensional space. In Step S150, comparison unit 110 reconstitutes the graph of the amount of deformation feature in the plurality of objects shown in FIG. 6 or FIG. 7 using multidimensional scaling, and points indicating proximity between objects in terms of the amount of deformation feature are plotted on a two-dimensional graph.

Squares a through d in FIG. 8 correspond to line segments a through d in FIG. 6 representing the amount of rotation by the plurality of objects (for example, the distance in terms of the amount of rotation feature R(t) from unit matrix I corresponding to a situation in which the object does not rotate), and the distance between squares a through d in FIG. 8 correspond to the distance between line segments a through d in FIG. 6 or to the distance between objects in terms of the amount of rotation feature R(t) (for example, the sum of the square of the difference of each element in the matrix).

In Step S160, display unit 112 displays a graph constructed using multidimensional scaling. In this way, display unit 112 can display the object related to square d, which is farther in distance from squares a through c, as an object with a different change aspect (for example, rotational or expansion and contraction aspect) in a manner that is easy to understand.

For example, because analysis device 100 can display on a graph the relationship between objects of different sizes and weights in terms of the amount of deformation feature, the influence of object size or weight on the simulation results can be visualized.

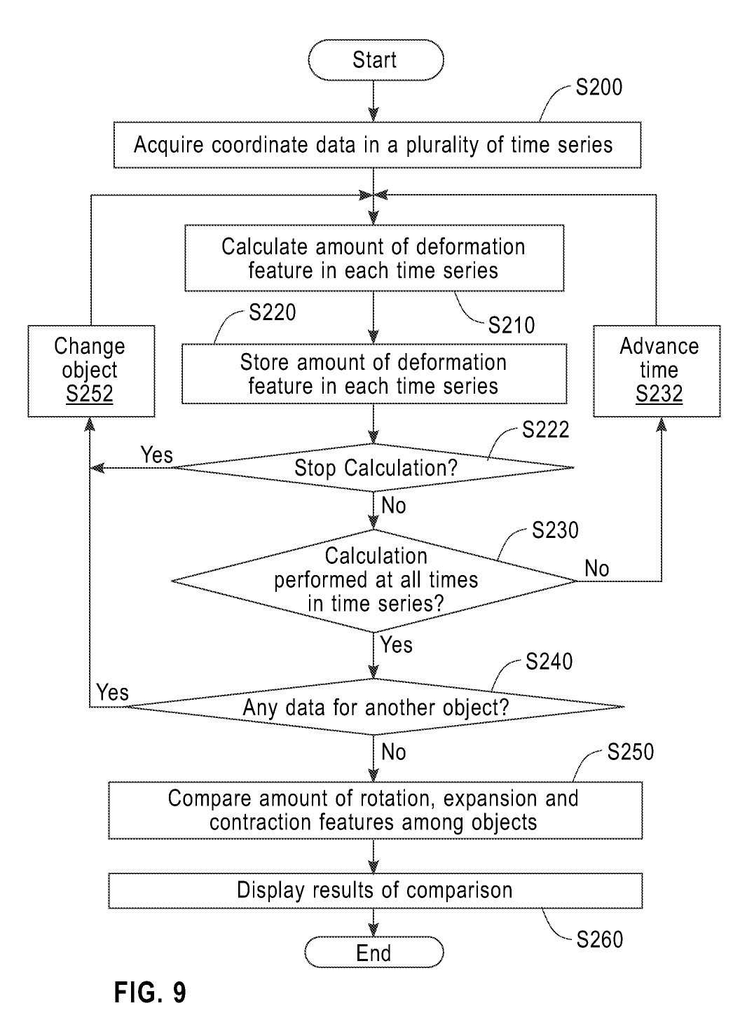

FIG. 9 shows the operational flow of the analysis method for a deformation in the embodiment. In the present deformation, analysis device 100 executes Steps S200 through S260.

In the present deformation, analysis device 100 can execute the process from Step S200 to Step S220 in the same manner as the process from Step S100 to Step S120 explained above with reference to FIG. 2. In the present deformation, the evaluation values allotted to each of the plurality of objects are stored in advance in storage unit 106. Storage unit 106 can also store, for example, evaluation values on the deformation of objects and/or evaluation values on the importance of objects. In the present deformation, analysis device 100 executes the process in Step S222 after the process in Step S220.

In Step S222, control unit 108 controls calculation unit 104 so as to terminate the calculation of the amount of deformation feature in an object when the amount of deformation feature in an object calculated at some of the times in a time series satisfies predetermined conditions.

For example, first, comparison unit 110 compares the amount of deformation feature calculated by calculation unit 104, for some of the times from the reference time to time t in a time series, to the amount of deformation feature at the corresponding times for a plurality of objects stored in storage unit 106.

At the time of Step S222, comparison unit 110 can compare the amount of deformation feature between objects in the time series from the reference time to time t using the same method as the one used in Step S150, on the basis of the time series data on the amount of deformation feature for all objects stored at the current time in storage unit 106. In this way, comparison unit 110 specifies other objects having an amount of deformation feature up to time t, or having an amount of deformation feature up to time t which resembles the object at or above a reference level. Comparison unit 110 supplies information on the other objects to control unit 108.

When an evaluation value assigned to another specified object has been retrieved from the storage unit 106 and the evaluation value assigned to the other object is equal to or less than a predetermined first reference value, control unit 108 advances the process to Step S252, and the priority is lowered for the process in which calculating unit 104 calculates the amount of deformation feature in the one object at the remaining times on or after time t. When calculation of the amount of deformation feature has been completed for the other objects, calculation unit 104 resumes calculation of the amount of deformation feature in the one object on or after time t that had been suspended.

Control unit 108 can force calculation unit 104 to suspend calculation of the amount of deformation feature in the one object for the remaining times on or after time t when the evaluation value assigned to another object is equal to or less than a second reference value which is lower than the first reference value. In this situation, control unit 108 does not allow for calculation unit 104 to calculate the amount of deformation feature in the one object on or after time t which had been suspended.

The processing in Step S222 does not have to be performed each time in the loop from Step S210 to Step S232. For example, it can be performed once every few loops or even once every several hundred loops. In the present deformation, analysis device 100 can perform the process from Step S230 to Step 260 in the same manner as the process from Step S130 to Step S160.

In the present invention, the computing resources of analysis device 100 can be employed more efficiently by lowering the priority or eliminating altogether calculations for the amount of deformation feature in an object whose deformation is similar to another object of low importance.

In the explanation of the present embodiment, time series data on object coordinates obtained from an object crash simulation was analyzed by analysis device 100. However, analysis device 100 can be used to analyze the results of any type of simulation in which objects are assumed to have become deformed. For example, analysis device 100 can be used to analyze results in which the objects are buildings and a simulation has been performed to determine the deformation of buildings (for example, the collapse of a building).

In the present embodiment, analysis device 100 also obtained and analyzed time series data for the three-dimensional coordinates of an object. However, instead of or in addition to this, time series data for three-dimensional vectors of the object such as velocity, acceleration and/or weight can be analyzed. Also, analysis device 100 can apply a low-pass filter to the time series data when analyzing time series data for the velocity, acceleration and/or weight of an object. In this way, analysis device 100 can analyze the collision of objects with greater precision.

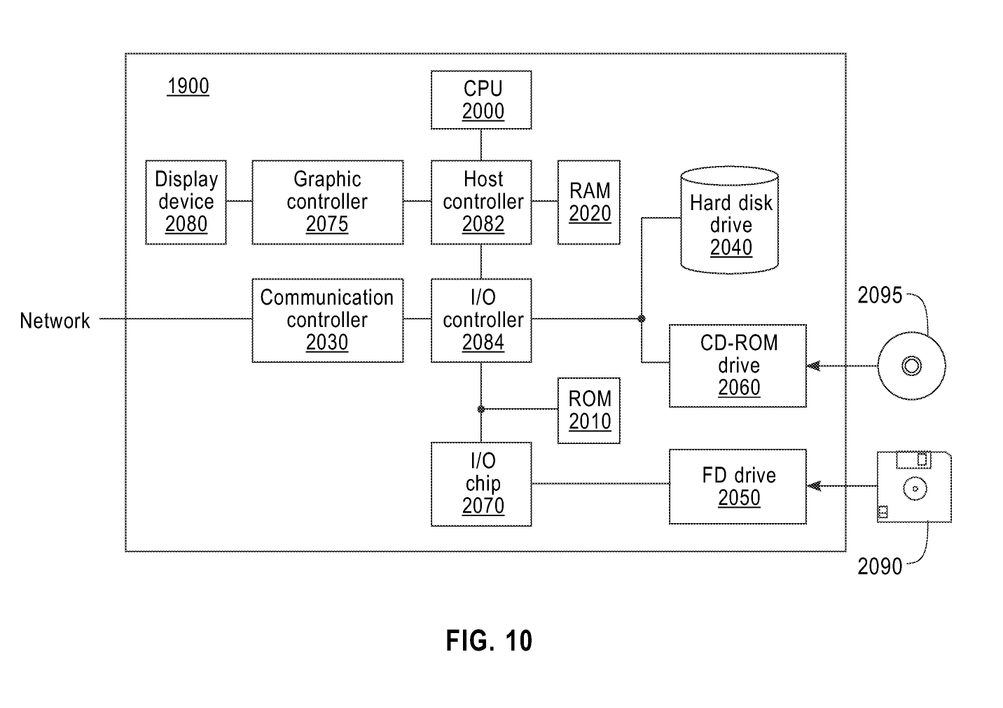

FIG. 10 shows an example of a hardware configuration for computer 1900 serving as analysis device 100 in the present embodiment. Computer 1900 in the present embodiment is equipped with a CPU peripheral portion having a CPU 2000, RAM 2020, graphics controller 2075 and display device 2080 connected to each other by a host controller 2082, an input/output portion having a communication interface 2030, a hard disk drive 2040 and a CD-ROM drive 2060 connected to the host controller 2082 by an input/output controller 2084, and a legacy input/output portion having a ROM 2010, flexible disk drive 2050, and input/output chip 2070 connected by the input/output controller 2084.

Host controller 2082 is connected to RAM 2020, a CPU 2000 accessing the RAM 2020 at a high transfer rate, and a graphics controller 2075. CPU 2000 is operated on the basis of a program stored in ROM 2010 and RAM 2020, and controls the various units.

Graphics controller 2075 acquires the image data generated in the frame buffer of RAM 2020 by CPU 2000 and other units, and displays this image data on display device 2080 via display unit 112. Alternatively, graphics controller 2075 can include a frame buffer for storing image data generated by CPU 2000 and other units.

The input/output controller 2084 connects a host controller 2082, a communication interface 2030 serving as a relatively high-speed input/output device, a hard disk drive 2040, and a CD-ROM drive 2060. Communication interface 2030 communicates with the other devices via a wired or wireless network.

The communication interface also functions as hardware for communication in analysis device 100. Hard disk drive 2040 stores the programs and data used by CPU 2000 in computer 1900. CD-ROM drive 2060 reads programs and data from CD-ROM 2095 and provides them to hard disk drive 2040 via RAM 2020.

ROM 2010, flexible disk drive 2050, and the relatively low-speed input/output device of input/output chip 2070 are connected by input/output controller 2084. ROM 2010 stores the boot program executed by computer 1900 at startup and/or programs relying on hardware in computer 1900.

Flexible disk drive 2050 reads programs or data from a flexible disk 2090, and provides the programs and data to hard disk drive 2040 via RAM 2020. Input/output chip 2070 connects flexible disk drive 2050 to input/output controller 2084, and various types of input/output devices are connected to input/output controller 2084 via a parallel port, serial port, keyboard port, or mouse port, etc.

A program provided to hard disk drive 2040 via RAM 2020 is stored on a recording medium such as a flexible disk 2090, CD-ROM 2095 or IC card, and provided by the user. A program is read from the recording medium, installed in hard disk drive 2040 inside computer 1900 via RAM 2020, and executed by CPU 2000.

Programs installed in computer 1900 to enable computer 1900 to function as an analysis device 100 include an acquisition module, calculation module, storage module, control module, comparison module, and display module.

These programs or modules can be activated by CPU 2000 to enable computer 1900 to function as an acquisition unit 102, a calculation unit 104, a storage unit 106, a control unit 108, a comparison unit 110, and a display unit 112.

The information processing steps written in these programs are specific means activated by reading the programs to computer 1900 so that the software cooperates with the various types of hardware resources described above. These specific means function as an acquisition unit 102, a calculation unit 104, a storage unit 106, a control unit 108, a comparison unit 110, and a display unit 112.

These specific means realize operations and the processing of information depending on the intended purpose of computer 1900 in the present embodiment in order to construct an analysis device 100 for this intended purpose.

For example, when computer 1900 communicates with an external device, CPU 2000 executes the communication program loaded in RAM 2020, and instructs communication interface 2030 with respect to communication processing on the basis of the processing content described in the communication program.

Communication interface 2030, subject to control by CPU 2000, reads the transmission data stored in the transmission buffer region of a memory device such as RAM 2020, hard disk drive 2040, flexible disk 2090 or CD-ROM 2095 and transmits the data to a network, or writes reception data received from the network to a reception buffer region of the storage device.

In this way, communication interface 2030 transfers transmitted and received data to the storage device using the DMA (Direct Memory Access) method. Alternatively, CPU 2000 transfers transmitted and received data by reading data from the source storage device or communication interface 2030, and transferring and writing data to a recipient communication interface 2030 or storage device.

Also, CPU 2000 writes all of the data or the necessary data to RAM 2020 via, for example, a DMA transfer, from files or databases stored in an external storage device such as a hard disk drive 2040, a CD-ROM drive 2060 (CD-ROM 2095) or a flexible disk drive 2050 (flexible disk 2090), and performs various types of processing on the data in RAM 2020.

Storage unit 106 can be mounted in or connected to an external storage device. CPU 2000 then writes the processed data to the external storage device via, for example, a DMA transfer. Because RAM 2020 temporarily stores the contents of the external storage device during this process, RAM 2020 and the external storage device are generally referred to in the present embodiment as memory, a storage unit, or a storage device.

The various types of information in the various types of programs, data, tables and databases of the present embodiment are stored in these memory devices, and are the targets of information processing. CPU 2000 can hold some of RAM 2020 in cache memory, and read and write data to the cache memory. Here, the cache memory performs some of the functions of RAM 2020. Therefore, this distinction is excluded in the present embodiment. Cache memory is included in RAM 2020, the memory, and/or the storage device.

CPU 2000 also performs various types of processing on data read from RAM 2020 including the operations, information processing, condition determination, and information retrieval and substitution described in the present embodiment and indicated by a sequence of instructions in the program, and writes the results to RAM 2020.

For example, when performing a condition determination, CPU 2000 compares various types of variables described in the present embodiment to other variables or constants to determine whether or not conditions such as greater than, less than, equal to or greater than, equal to or less than or equal to have been satisfied. When a condition has been satisfied (or not satisfied), the process branches to a different sequence of instructions or calls a subroutine.

CPU 2000 can also retrieve information stored in files and databases inside the memory device. For example, when a plurality of entries associating an attribute value for a second attribute with an attribute value for a first attribute are stored on a storage device, CPU 2000 can retrieve an entry matching the conditions indicated by the attribute value of the first attribute among the plurality of entries, and then obtain the attribute value of the second value associated with the first value satisfying a predetermined condition by reading the attribute values of the second attributes stored in the entries.

A program or module described above can be stored in a recording medium of an external unit. Instead of a flexible disk 2090 or a CD-ROM 2095, the recording medium can be an optical recording medium such as a DVD or CD, a magneto-optical recording medium such as MO, a tape medium, or a semiconductor memory such as an IC card. The recording medium can also be a storage device such as a hard disk or RAM provided in a server system connected to a dedicated communication network or the internet, and the program can be provided to the computer 1900 via the network.

The present invention was explained using an embodiment, but the technical scope of the present invention is not limited to the embodiment described above. The possibility of many changes and improvements to this embodiment should be apparent to those skilled in the art. Embodiments including these changes and improvements are within the technical scope of the present invention, as should be clear from the description of the claims.

The order of execution for operations, steps and processes in the devices, systems, programs and methods described in the claims, description and drawings was described using such terms as “previous” and “prior”. However, these operations, steps and processes can be realized in any order as long as the output of a previous process is used by a subsequent process. The operational flow in the claims, description and drawings were explained using terms such as “first” and “next” for the sake of convenience. However, the operational flow does not necessarily have to be executed in this order.

What is claimed is:

1. A device for analyzing deformation in an object, the device comprising:
a memory;
a processor device communicatively coupled to the memory; and
a module for analyzing deformation in an object coupled to the memory and the processor device to operate the following units:
an acquisition unit for acquiring coordinate data along a time series at a plurality of points in the object;
a calculation unit for calculating an amount of deformation feature indicating an amount of deformation in the object over time from the coordinate data at the plurality of points at each time in the time series; and
a storage unit for setting the time series data for the amount of deformation feature as data for specifying a deformed state of the object, associating said data with the object, and storing the associated data.

2. The device according to claim 1, wherein the deformed state of the object includes the deformed state of the object over time.

3. The device according to claim 1, further comprising a comparison unit for comparing the time series data for the amount of deformation feature in a plurality of objects.

4. The device according to claim 3, wherein the amount of deformation feature includes at least either an amount of rotation feature indicating an amount of rotation by the object around a center of gravity of the object, and an amount of expansion and contraction feature indicating an amount of expansion or contraction of the object.

5. The device according to claim 4, wherein the calculation unit calculates the amount of rotation feature by the object and the amount of expansion and contraction feature so as to minimize a difference between the coordinate data of the object at each time along the time series and the coordinate data of the object at a reference time when the object has been rotated, expanded and contracted.

6. The device according to claim 4, wherein the comparison unit compares a distance in time series data points for at least either the amount of rotation feature and the amount of expansion and contraction feature.

7. The device according to claim 4, wherein the calculation unit calculates the amount of rotation feature and the amount of expansion and contraction feature using shape analysis.

8. The device according to claim 7, wherein the calculation unit calculates the amount of rotation feature from a result obtained by performing a singular value analysis on a product of a matrix obtained from the coordinate data of the object at a plurality of times along the time series and a matrix obtained from the coordinate data of the object at a reference time.

9. The device according to claim 1, wherein the object is a vehicle, and the coordinate data of the object along the time series is from a crash simulation performed on the vehicle.

10. The device according to claim 3, wherein the storage unit stores object information related to object deformation associated with at least one object and inputted by a user;
the comparison unit specifies another object similar to the at least one object in the time series data of the amount of deformation feature; and
a display unit for displaying the object information associated with the other object specified.

11. The device according to claim 3, wherein the storage unit stores an evaluation value assigned to each of the plurality of objects;
the comparison unit compares the amount of deformation feature calculated by the calculation unit at a set of times in the time series and the amount of deformation feature at a time corresponding to the plurality of objects and stored in the storage unit; and
the device further includes a control unit for reducing a priority for calculating the amount of deformation feature in the at least one object at remaining times when the amount of deformation feature in the at least one object at each time is similar to the amount of deformation feature in the other object specified at each time by more than a reference value, and the evaluation value assigned to the other object specified is equal to or less than a first reference value.

12. The device according to claim 11, wherein the control unit stops calculating the amount of deformation feature in the at least one object at the remaining times when the amount of deformation feature in the at least one object at each time is similar to the amount of deformation feature in the other object specified at each time by more than the reference value, and the evaluation value assigned to the other object specified is equal to or less than a second reference value, the second reference value being lower than the first reference value.

13. A method for analyzing deformation in an object, the method comprising:
acquiring coordinate data along a time series at a plurality of points in the object;
calculating an amount of deformation feature indicating an amount of deformation in the object over time from the coordinate data at the plurality of points at each time in the time series; and
setting the time series data for the amount of deformation feature as data for specifying a deformed state of the object, associating said data with the object, and storing the associated data.

14. The method according to claim 13, wherein the deformed state of the object includes the deformed state of the object over time.

15. The method according to claim 13, further comprising comparing the time series data for the amount of deformation feature in a plurality of objects.

16. The method according to claim 15, wherein the amount of deformation feature includes at least either an amount of rotation feature indicating an amount of rotation by the object around a center of gravity of the object, and an amount of expansion and contraction feature indicating an amount of expansion or contraction of the object.

17. The method according to claim 16, wherein calculating the amount of deformation feature includes calculating the amount of rotation feature by the object and the amount of expansion and contraction feature so as to minimize a difference between the coordinate data of the object at each time along the time series and the coordinate data of the object at a reference time when the object has been rotated, expanded and contracted.

18. The method according to claim 16, wherein comparing the time series data for the amount of deformation feature includes comparing compares a distance in time series data points for at least either the amount of rotation feature and the amount of expansion and contraction feature.

19. The method according to claim 16, wherein calculating the amount of rotation feature and the amount of expansion and contraction features includes using shape analysis.

20. A non-transitory computer program product for analyzing deformation in an object, said non-transitory computer program product comprising a computer readable storage medium having program instructions embodied therewith, the program instructions readable/executable by a device to cause the device to perform a method comprising:
acquiring coordinate data along a time series at a plurality of points in the object;
calculating an amount of deformation feature indicating an amount of deformation in the object over time from the coordinate data at the plurality of points at each time in the time series; and
setting the time series data for the amount of deformation feature as data for specifying a deformed state of the object, associating said data with the object, and storing the associated data.
